(19) United States
(12) Patent Application Publication
(10) Pub. No.: US 2005/0249555 A1
(43) Pub. Date: Nov. 10, 2005

(54) Open or closed ended tire pipe apparatus and method

(76) Inventor: Ray Stratton Coffey JR., Staunton, VA (US)

Correspondence Address: Ray S. Coffey, Jr., POB 70, Craigsville, VA, 24430, US

(21) Appl. No.: 10/816,315

(22) Filed: Apr. 2, 2004

(51) Int. Cl. E03F 1/00; E02B 13/00; B01D 12/00

(52) U.S. Cl. 405/36; 405/46; 210/532.1

(57) ABSTRACT

A simplified method of utilizing used vehicle tires in the construction of a waste fluid treatment system, and an apparatus for carrying out the same method, am disclosed. The apparatus according to the invention comprises tires cemented with industrial glue to form sewage sedimentation and disposal chambers. A minimum of new materials and labor are required in the method and apparatus resulting in additional environmental and economic savings.

### CROSS-REFERENCES TO RELATED APPLICATIONS

US Patent Documents

| | | | |
|---|---|---|---|
| US-2002/0179511 | 12-2002 | WOFFORD | 210/151 |
| US-2002/0179510 | 12-2002 | WOFFORD | 210/151 |
| U.S. Pat No. 5,941,238 | 08-1999 | TRACY | 126/641 |
| U.S. Pat No. 4,824,287 | 04-1989 | TRACY | 405/36 |

Foreign Patent Documents

| | | | |
|---|---|---|---|
| 2221479 | 02-1990 | TRACY | GREAT BRITAIN |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates generally to sewage treatment systems, specifically to a system composed primarily of used vehicle tires.

2. Description of the Related Art Including Information Disclosed Under 37CFR 1.97 and 1.98

Lawrence Tracy disclosed a sewage treatment system in Great Britain patent 2221479 utilizing discarded vehicle tires. Similar systems, termed “chamber” or “infiltrator” units are legally permitted and installed in Virginia and other United States for home construction. These systems, and the invention described herein, differ from the Tracy invention in that neither require a distribution pipe or gravel, as required in the Tracy configuration. Gravel is a major expense, and gravel placement is a major labor requirement in septic systems utilizing gravel. The use of a distribution pipe in the Tracy design requires cutting large holes in

[symbol]

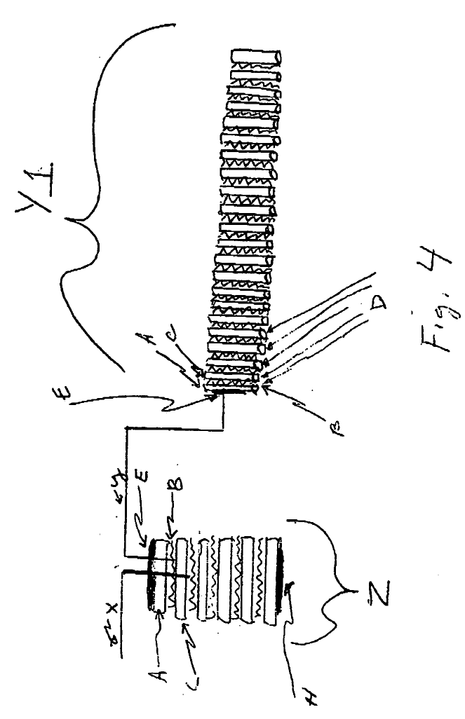

FIG. 3 is a frontal view of a used tire prepared for drainage of treated sewage by addition of an aperture. Z

FIG. 4 is a side view of one example of a completed sewage treatment system primarily of used tires.

FIG. 5 is a top view of a plastic plate used to seal a tire except for pipe entry apertures.

FIG. 6 is a top view of a plastic plate used to seal a used tire.

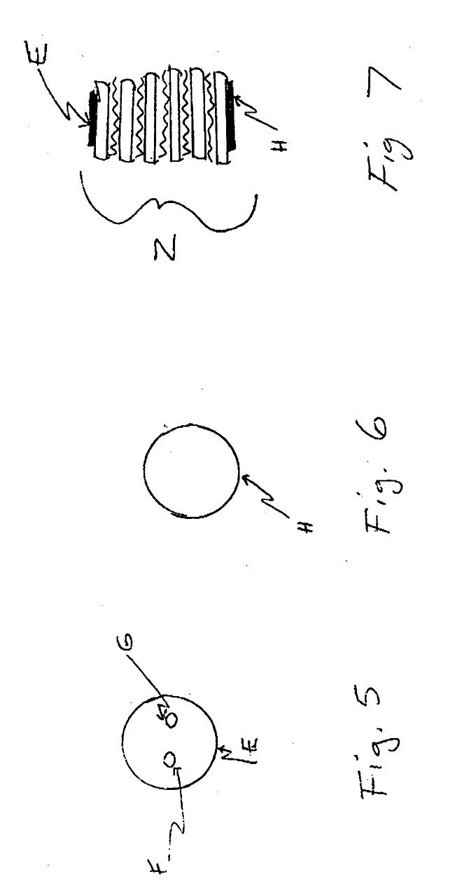

FIG. 7 is a side view of a septic tank or pump tank unit constructed of used tires and plastic plates..

### DETAILED DESCRIPTION OF THE INVENTION

To attain the objects as noted above the inventor analyzed established and innovative sewage treatment systems with a view to replacing new manufactured components with waste materials, while identifying the minimum components required for an operational unit. It was found that used vehicle tires could replace new molded plastic chamber components as well as concrete septic tanks with a minimum of modification. The invention is predicated in this finding.

More particularly, the present invention features the method of gluing used tires together to instantly construct a tank or chamber for use in sewage treatment.

Further, the invention features an apparatus, which comprises a settling tank manufactured from used tires connected by a pipe to a sewage treatment chamber or chambers constructed of used tires.

Briefly, according to the invention used tires are glued together with industrial glue to form components of as sewage treatment system. To form a septic tank the section of glued tires is capped with a plastic plate with pipe apertures and a plastic plate without apertures is glued to the bottom of said tank. The section of tires glued together to form a chamber is capped at the anterior end with a glued on plastic plate with a pipe aperture. The tires are further enhanced by the addition of apertures in the bottom edge of the tires to allow drainage of the treated sewage.

Now, preferred embodiments of the invention will be described with reference to the drawings.

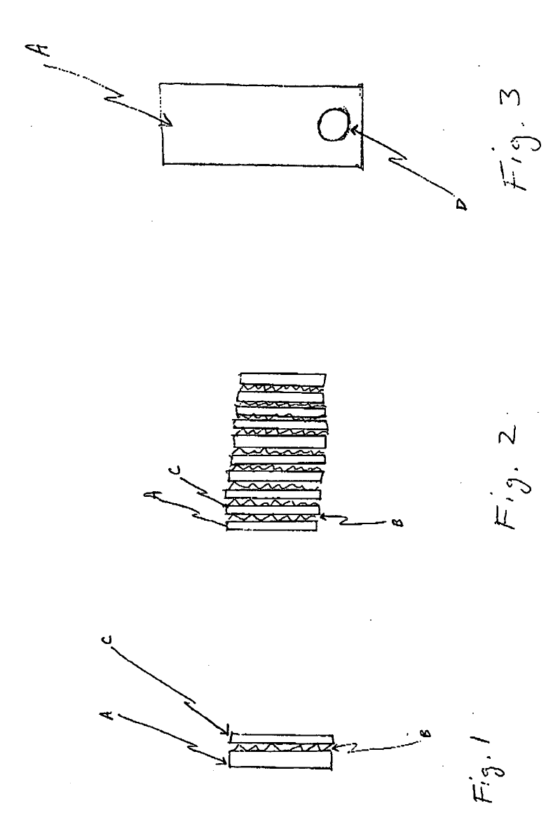

FIG. 1 is a side view showing an embodiment of the present invention. More specifically, the Figure shows an apparatus, which comprises a used tire A cemented to used tire C with industrial glue B. This is the building block unit of the invention. The process of gluing used tires together is continued as necessary to produce an apparatus of the desired dimensions.

This process results in a component, as in FIG. 2, in this illustration many tires glued together to the desired dimension as referenced above. This component in the illustrated horizontal orientation would be utilized as a sewage storage and treatment chamber in the preferred embodiment of the current invention.

FIG. 3 is a frontal view of used tire A prepared for drainage of sewage effluent by the cutting of aperture D. The size of aperture D can be adjusted to varying soil conditions, desired wastewater residence times, and other variables. For example, in sandy soils the apertures could be larger as the soil is able to absorb the fluid more rapidly than in clay soils.

FIG. 4 is a side view of one example of the preferred embodiment, a completed sewage treatment system composed primarily of used tires in this example, unit Z, a sedimentation basin resulting from a vertical orientation of the process of repeatedly cementing tires together as described above, receives sewage from pipe X. Pipe X passes through plastic lid E which is glued onto tire A. The sewage is contained within the cemented tires by bottom cap H. The clarified effluent passes through pipe Y up through cover plate E and into the drain field chamber through another plate E with a single pipe aperture. Used tire A is glued to used tire C with industrial glue B, add this process is repeated with successive tires and glue until the desired component dimensions are achieved. Sewage flows from pipe Y, through end plate E, into the horizontally oriented sewage disposal chamber Y1. The treated sewage effluent flows down the length of the chamber Y1, draining through apertures D Into the soil.

Now, the plates covering the ends of the chambers are detailed. In FIG. 5, plastic plate E of sufficient size to cover the original tire hole of the first tire A in FIG. 4 is outfitted with holes P and G to allow passage of sewage influent and effluent pipes X and Y in FIG. 4.

FIG. 6 is atop view of plastic plate H in FIG. 4 which serves to seal the bottom of the sedimentation basin Z in FIG. 4. Plastic plate H is of sufficient size to cover the end of the last tire of component Z in FIG. 4 designed to contain wastewater for sufficient time to allow proper sedimentation. This is further illustrated in FIG. 7 in which the used tire assembly labeled sedimentation basin Z in FIG. 4 is sealed with impermeable plate H on the bottom and covered with permeable plate E on top as shown in FIG. 4. Component Z in FIG. 7 may be considered a generic component for wastewater treatment, and utilized in either a horizontal or vertical orientation and with or without watertight seal plate H or permeable cover E.

The specifics contained in the above description should not be counted as limits on the scope of the invention. Many variation are possible within the teachings of the invention. For example, the basic sealed multiple tire chamber could be utilized as a clear well, wetland cell, distribution box, or other sewage treatment unit. In addition, liquid wastes other than sewage can be processed with this invention.

Thus the scope of the invention should be determined by the following claims and their legal equivalents.

1. A treatment system which dots not require a distribution pipe or gravel media for processing sewage and other fluids from homes, business, farms or other properties, comprising:
A. vertically oriented sedimentation and horizontally oriented disposal chambers composed of used tires cemented in axial alignment with industry glue;
B. plastic plates cemented to the ends of said tire assemblies forming water-tight chambers, said plastic plates possessing apertures necessary for passage of pipes cTying sewage influent and effluent;
C. pipes to conduct influent to said sedimentation chambers;
D. pipes to conduct effluent from said sedimentation chambers to said disposal chambers;
E. said horizontal disposal consisting of used tires cemented together and with apertures drilled into the bottom tires edges to allow drainage of effluent into the soil.

2. A method for construction of a sewage or other fluid treatment tem from used tires comprising:
A. cementing used tires in axial alignment with industrial glue;
B. orienting said tire assembles in a vertical direction to form a sedimentation basin;
C. orienting aid tire assemblies in a horizontal direction to form a disposal chamber:
D. cementing plastic plates to the open ends of said chambers ti) rorn watertight containers;
En cutting apertures in said plates to allow passage of influent and effluent pipes as necessary;
F. attaching an influent pipe into said sedimentation basin through said aperture in said plastic plate sealing said sedimentation basin;
G. attaching an effluent pipe into said sedimentation basin through said aperture in said plastic plate sealing said sedimentation basin;
H. attaching said effluent pipe from said sedimentation basin into said disposal chamber through said aperture in said plastic plate sealing said disposal chamber;
